(19) United States
(12) Patent Application Publication
(10) Pub. No.: US 2013/0091013 A1
(43) Pub. Date: Apr. 11, 2013

(54) Presenting Targeted Social Advertisements

(71) Applicants: Taifeng Wang, Beijing (CN); Tie-Yan Liu, Beijing (CN)

(72) Inventors: Taifeng Wang, Beijing (CN); Tie-Yan Liu, Beijing (CN)

(73) Assignee: Microsoft Corporation, Redmond, WA (US)

(21) Appl. No.: 13/268,078

(22) Filed: Oct. 7, 2011

(51) Int. Cl. G06Q 30/02

(52) U.S. Cl. 705/14.53

(57) ABSTRACT

Techniques for providing targeted social advertisements in a social network are described. A targeted social advertisement application detects a commercial intent of a user and retrieves input from friends in the social network. In an implementation, a user interface includes a pane to display a comment with the commercial intent submitted by the user in the social network, the commercial intent being detected for a potential product. The user interface also includes a voting pane to display a plurality of candidate products targeted towards the commercial intent of the user for the potential product. One or more command buttons are on the voting pane to prompt voting as recommendations for the plurality of candidate products from friends of the user.

### BACKGROUND

Social networking plays an important role in the daily lives of most individuals. The increasing popularity of social networking websites provides many opportunities for individuals to maintain social relationships and to share information with others, usually on personal and/or business matters. Based on the popularity of the social networking websites, companies are placing advertisements for their products and services on the social networking websites, known as social networking advertising.

Typically, there are problems with the social networking advertisements placed on the social networking websites. The advertisements are not particularly targeted towards the individuals but tend to be based on demographic information of users, such as a broad target group. For example, an advertisement may be directed towards the individuals that have an interest in purchasing a vehicle without consideration of a size, a style, or a type of vehicle. A problem is the social networking websites do not identify a main product and/or a service that the individuals are interested in purchasing at the time.

Furthermore, the social networking advertising tends to copy a model of a sponsor search or contextual advertising. For instance, contextual advertising is a form of targeted advertising that often appear on websites or other media, selected, and served by automated systems based on keywords in a user's query. Other problems occur in trying to retrieve related information for the social networking advertising, when the main product or service has not been properly identified. For example, an individual may desire to purchase football tickets to see team “X.” Based on querying a name of team “X,” the advertisements may show football clothing, memorabilia of the team, or other types of souvenirs but nothing for purchasing tickets to a game.

### SUMMARY

This disclosure describes creating social advertisements targeted toward a commercial intent of a user with input from friends in the social network. In an implementation, a user interface includes a pane to display a comment with the commercial intent submitted by the user in the social network, the commercial intent being detected for a potential product. The user interface also includes a voting pane to display a plurality of candidate products targeted towards the commercial intent of the user for the potential product. One or more command buttons are on the voting pane to prompt voting as recommendations for the plurality of candidate products from friends of the user. Next, a results pane presents targeted social advertisements of a plurality of products from the plurality of candidate products in response to the commercial intent and votes from the friends of the user.

In another implementation, a system includes an intent targeting model component executed by a processor to retrieve a webpage of a user expressing commercial intent for a potential product and to further retrieve a plurality of candidate products targeted towards the commercial intent of the user for the potential product. The system also includes a voting model component to compute a number of votes for the plurality of candidate products from friends of the user, and a product generator component to provide a visualization of a plurality of products with values given for features based receiving a highest number of votes assigned by the friends in recognizing the commercial intent of the user.

In yet another implementation, one or more computer-readable storage media presents a plurality of products selected by friends of a user in a social network from a plurality of candidate products, the selecting by the friends being based on detecting a commercial intent of the user identified for a potential product. Next, the one or more computer-readable storage media receives input on features of the plurality of products in an interactive format, and the input causes a recalculation of a number of votes to rearrange an order of presenting the plurality of products.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows an example architectural environment for presenting targeted social advertisements to a user.

FIG. 2 shows a flowchart of illustrative phases for implementing a targeted social advertisement application by the architecture of FIG. 1.

FIG. 3 shows an illustrative user interface (UI) for presenting the targeted social advertisements of the plurality of products to the user.

FIG. 4 shows an example process for detecting commercial intent of the user for a potential product.

FIG. 5 shows an example process for presenting to friends a plurality of candidate products targeted towards the commercial intent.

FIG. 6 shows an example process for receiving votes from the friends for the plurality of candidate products to identify a plurality of products.

FIG. 7 shows an illustrative UI for presenting a hint to the user 102 when commercial intent of the user has been detected.

FIG. 8 shows another illustrative UI for presenting a hint to the friends when commercial intent of the user has been detected.

FIG. 9 shows another illustrative UI for presenting the targeted social advertisements of the plurality of products with conversation histories.

FIG. 10 shows another illustrative UI for presenting the targeted social advertisements of the plurality of products without displaying conversation histories.

FIG. 11 shows another illustrative UI for displaying a targeted social advertisement in a side pane and the plurality of products in a scroll form.

FIG. 12 shows a block diagram of an illustrative social networking server with selected components to implement a targeted social advertisements application.

### DETAILED DESCRIPTION

### Overview

A social networking service provides access for a user and friends of the user to a social networking website. There are many types of social networking websites available for the user and the friends of the user, based on shared common interests, relationships, beliefs, and goals. The user and the friends tend to share information quite often in the social networking website. Based on this sharing of information, a process presents social advertisements targeted towards a commercial intent of the user for a potential product with input received from the friends for recommending products.

This disclosure offers advertisers, companies, corporations, and suppliers an opportunity to engage in online efforts to advertise their products or their services through social networks. A targeted social advertisement (TSA) application directs the advertisements to a specific product interest of the user versus general demographic information of the user. In addition, the TSA application prompts friends of the user to provide votes, comments, or feedback for the products and the advertisers. Thus, the TSA Application enhances user experience by providing advertisements directed toward the specific product interest, providing side-by-side visual comparisons of the products, and relying on input from the friends that the user trusts or values their recommendations.

Typically, the user shares with friends by posting a comment on the social networking website. For instance, the comment may express commercial intent for the potential product. The social networking website may host the TSA application. In particular, the TSA application alerts the user that commercial information is readily available once the user expresses the commercial intent in purchasing the potential product or the service.

A user interface (UI) presents the targeted social advertisements of a plurality of products displayed on a screen. The UI presents the plurality of products in a side-by-side configuration to enable ease of comparison of two or more products. The user may navigate around keywords describing features of the plurality of products. In an implementation, different colors or patterns may be associated to certain features to provide visual cues that aid the user when looking for patterns of features in the data or at various types of content in the data. Overall, the user interface fosters an intuitive and viewer friendly environment for quickly viewing the plurality of products presented as targeted social advertisements.

While aspects of described techniques can be implemented in any number of different computing systems, environments, and/or configurations, implementations are described in the context of the following illustrative computing environment.

### Illustrative Environment and Phases

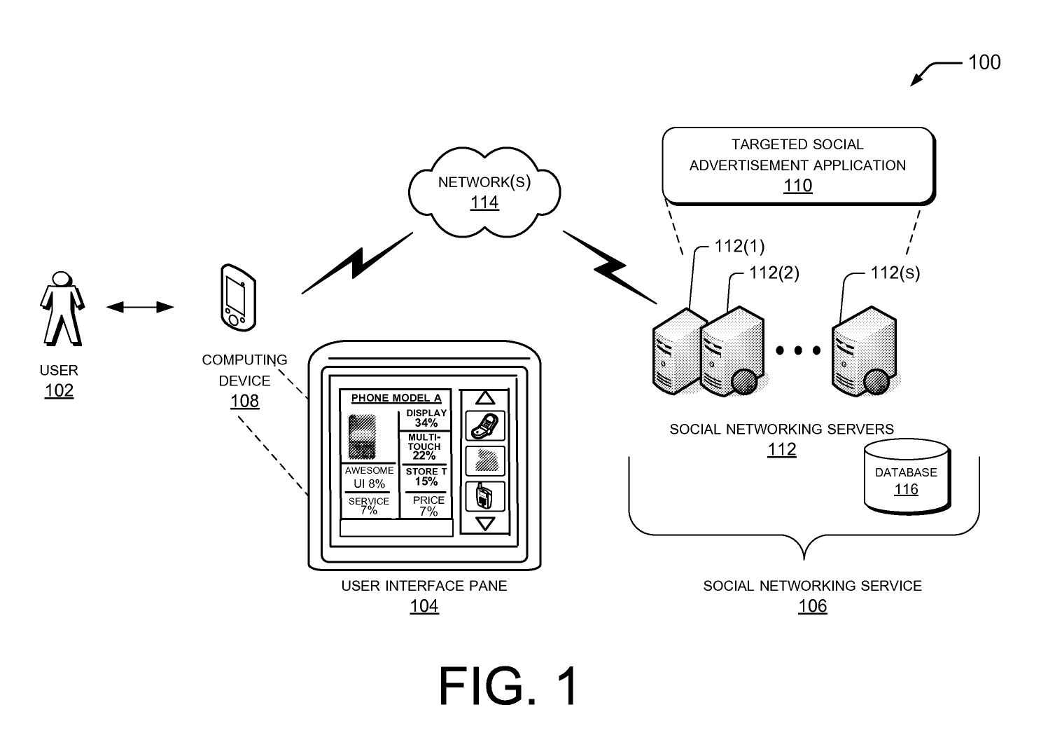

FIG. 1 is a diagram of an illustrative architectural environment 100 that enables the user 102 to view targeted social advertisements of the plurality of products displayed in a user interface (UI) pane 104. The user 102 may also interact with the UI pane 104 in various ways, such as by communicating with friends, activating links to advertisers' websites, or recommending a product from the targeted social advertisements to the friends in a social network.

The environment 100 includes a social networking service 106 that may be accessed by a computing device 108 to social networking websites. The service 106 in this embodiment may be implemented by a social network website or the TSA application 110, which in turn executes on one or more social networking servers 112(1) . . . 112(S).

The exemplary computing device 108 is shown as a mobile device. The computing device 108 may take a variety of forms, including, but not limited to, a portable handheld computing device (e.g., a smart phone, a cellular phone, a personal digital assistant), a laptop computer, a portable media player, a tablet computer, a netbook, or any other device capable of receiving targeted social advertisements and connecting to one or more network(s) 114.

The network(s) 114 represents any type of communications network(s), including wire-based networks (e.g., public switched telephone, cable, and data networks) and wireless networks (e.g., cellular, satellite, WiFi, and Bluetooth).

The TSA application 110 may comprise a data-based application implemented as part of a social networking website to provide targeted social advertisements to the user 102. The TSA application 110 organizes a huge volume of data of products of advertisers, enables visual data analysis of the plurality of products, and enables information sharing among users and friends at the same time. The TSA application 110 and the social networking server 112 may each be a component that includes additional sub-components, sub-modules, or works in conjunction with other modules or components to perform the operations discussed below.

The social networking servers 112(1)-(S) may be configured as plural independent servers, or as a collection of servers that are configured to perform larger scale functions accessible by the network(s) 114. The social networking servers 112(1)-(S) may be administered or hosted by a network service provider.

The environment 100 may also include an online database 116, which may be a separate server or may be a part of the representative set of servers 112 that is accessible via the network(s) 114. The online database 116 may host the huge volume of data of products or services of advertisers or suppliers, host ratings for the advertisers, host auction data to discussed later, host data layouts of the advertisers, store information generated by the TSA application 110, store customized views of the targeted social advertisements, store algorithms, and may be updated on a predetermined time interval.

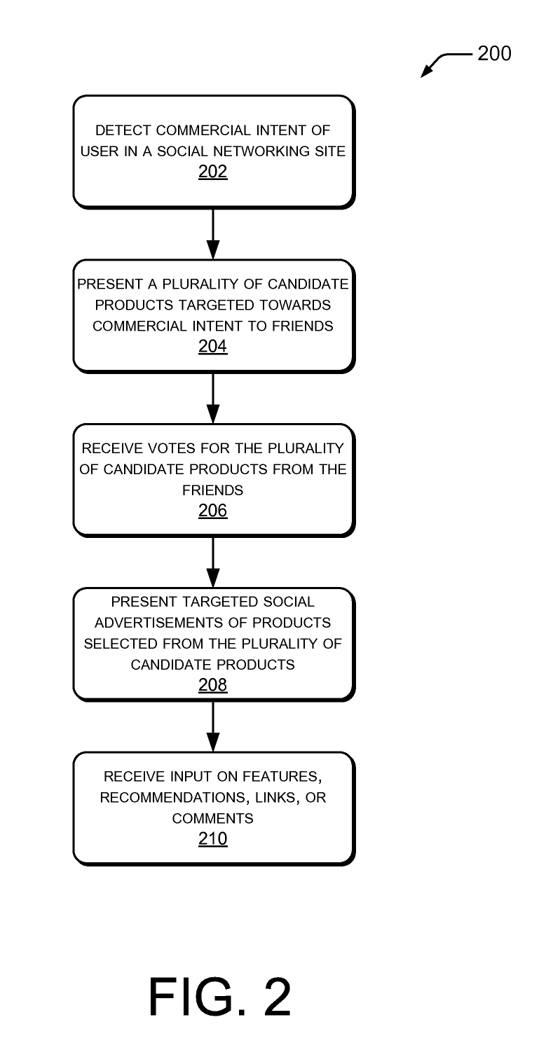

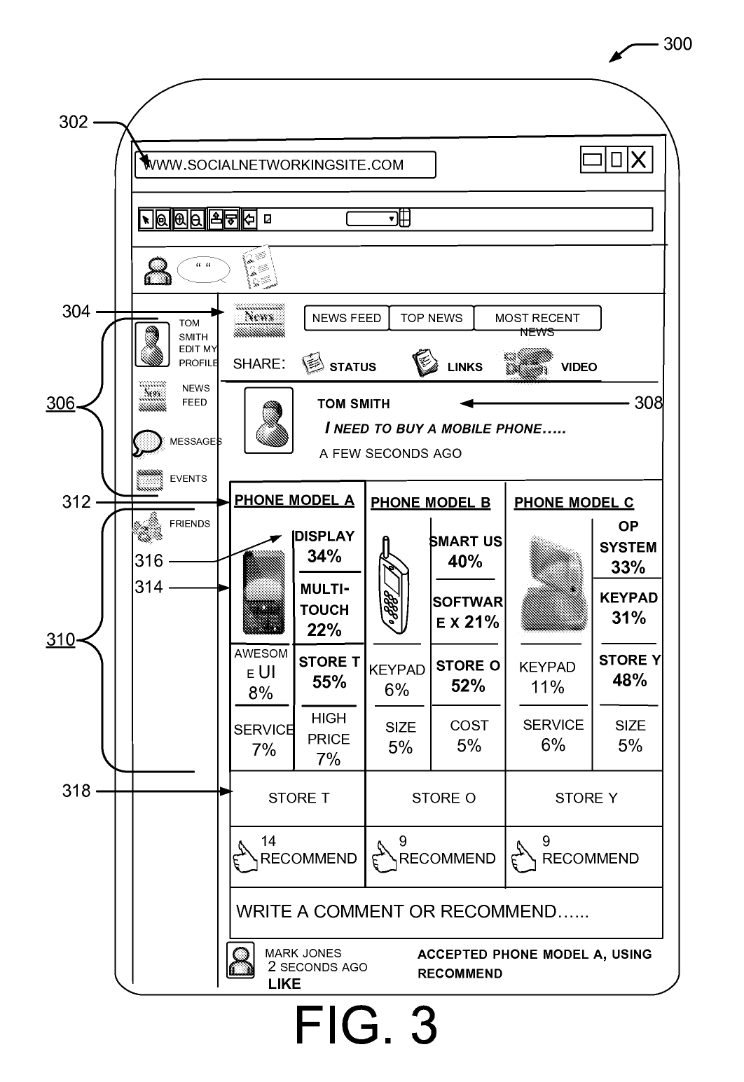

FIG. 2 is a flowchart showing an illustrative overview process 200 of high-level functions for implementing the targeted social advertisement in the environment of FIG. 1. The process 200 includes five phases: an initial phase 202 to detect commercial intent of the user in a social networking site, a second phase 204 to present the plurality of candidate products targeted towards the commercial intent to friends of the user, a third phase 206 to receive votes for the plurality of candidate products from the friends, a fourth phase 208 to present targeted social advertisements of products selected from the plurality of candidate products, and a fifth phase 210 to receive input on features, recommendations, links, or comments. Each of the illustrated phases may be implemented in the environment of FIG. 1, and may be performed separately or in combination without any particular order. Details of the high-level functions illustrated in FIG. 2 are further discussed with reference to FIGS. 3-12 below.

### Exemplary User Interface Implementation

FIG. 3 shows an illustrative user interface (UI) 300 for presenting to the user 102 the targeted social advertisements of the plurality of products. The TSA application 110 may collect comments and/or information from the user 102 and the friends who have given permission for their information to be collected and analyzed as part of being a member of the social network. In an implementation, the UI 300 is a browser-based UI 302 that presents a web page from the social networking website. The UI 300 also illustrates examples of social network scenario, such as “News Feed,” “Top News,” “Most Recent News” at 304. In a side pane on the left side, the UI 300 further illustrates examples of the social network scenario, such as “Tom Smith, Edit My Profile,” “News Feed, “Messages,” “Events,” and “Friends” at 306.

In a comment pane 308, Tom Smith submits on the webpage “I need to buy a mobile phone.” Based on this comment and activating the gathering of data by the user 102, the TSA application 110 collects, analyzes, and presents a visualization of three products along with features of the products 310 as the targeted social advertisements on the UI 300. The TSA application 110 presents the plurality of products in a side-by-side horizontal configuration enabling ease of comparison of two or more products. In another implementation, the TSA application 110 may present the plurality of products in a vertical configuration for ease of scrolling. In other implementations, the TSA application 110 may present photographs of each product as thumbnails.

The TSA application 110 arranges a layout of the products for the targeted social advertisements. For example, shown at 312 are three products with generic titles of “Phone Model A,” “Phone Model B,” and “Phone Model C.” In another implementation, trademarks, logos, actual product names, or brands may be used as identifiers. Turning to “Phone Model A,” as an example, the UI 300 displays an image 314 of the product to help the user 102 in making their purchase decision. At 316, the UI 300 displays features of the product having received a value assigned by the friends of the user 102. The value for each feature represents a percentage based on a popularity level assigned by the friends. For instance, “Display 34%” indicates the display is one of a top feature to be considered for Phone Model A. The image 314 illustrates that the display on the phone is rather large, which may be a strong selling feature for Phone Model A.

Moving down from “Display 34%,” is “Multi-Touch 22%” which indicates another feature for Phone Model A. Next is “Store T 55%” which is a name of an advertiser that is selling this product, along with a percentage rating of 55% by the friends of the user. Moving further down to “High Price 7%” indicates that the friends perceived the price for Phone Model A not an important feature. Also shown are “Awesome UI 8%” and “Service 7%.”

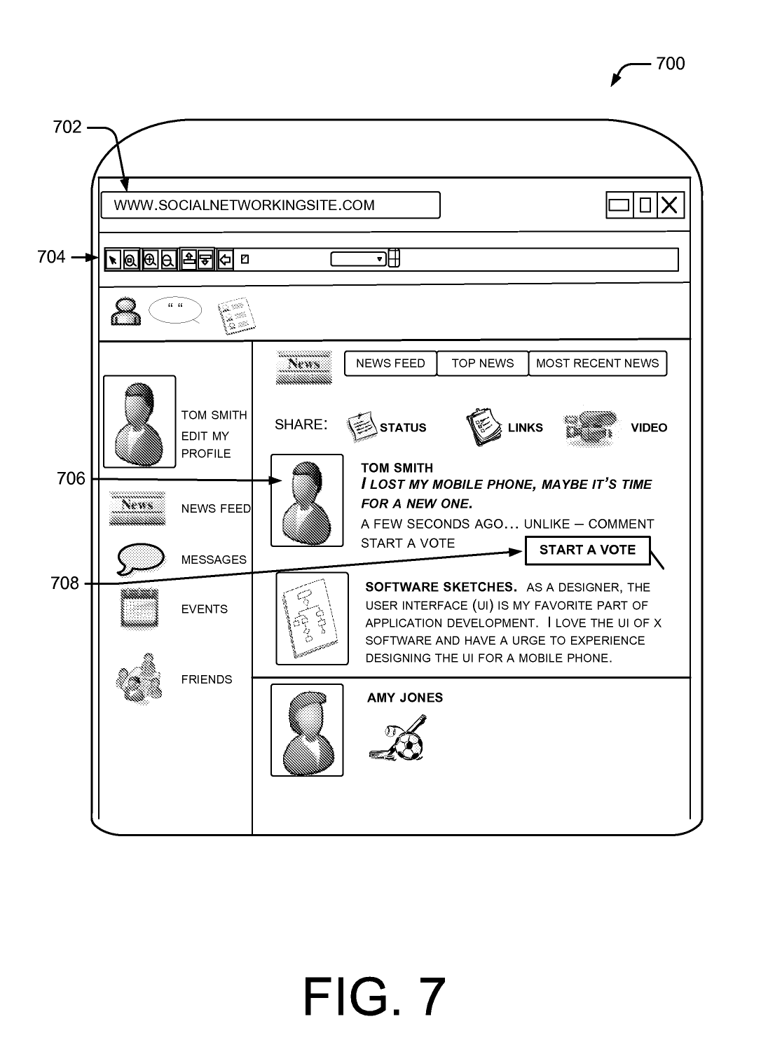

Shown at 318 are links to each advertiser's website, “Store T,” “Store O,” and “Store Y.” Additional details of the targeted social advertisements in the UI are discussed with reference to FIGS. 7-11.

### Exemplary Processes for Implementing Targeted Social Advertisements

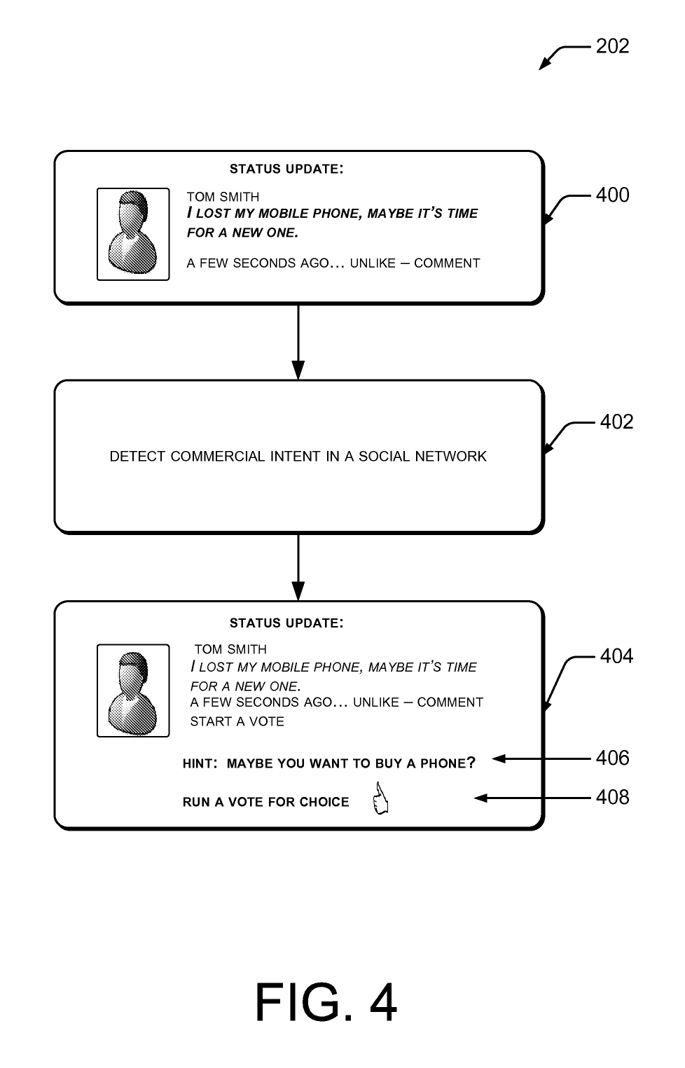

FIGS. 4-6 are example processes for creating targeted social advertisements. FIG. 4 shows an example process 202 for identifying commercial intent of the user 102 for the potential product (discussed at a high level above). Block 400 illustrates a screen shot taken from the webpage on the social network. The “Status Update” in 400 illustrates the user “Tom Smith” providing a comment or starting a conversation with a friend by submitting, “I lost my mobile phone, maybe it's time for a new one.”

The TSA application 110 monitors when comments are being submitted on the social network. The TSA application 110 analyzes the comments to detect the commercial intent of the user 102 for the potential product in the social network 402. For example, the TSA application 110 identifies one or more keywords, such as “lost,” “mobile phone,” “new one,” by associating the keywords with words that are commonly associated with products or services to detect commercial intent of “buy a mobile phone.” In the implementations discussed, commercial intent includes products but may be applied for services as well.

At 404, the TSA application 110 may provide a hint to the user 102 without being intrusive. For instance, the TSA application 110 may send an inquiry of “Maybe you want to buy a phone?” 406. Another hint the TSA application 110 may send is “Run a vote for choice,” with a thumbs up icon 408 indicating the user 102 may activate the voting of friends for commercial information. On activating the “Run a vote for choice” thumbs-up icon button, the TSA application 110 collects the data, analyzes the data, and then delivers targets social advertisements to the webpage of the user 102.

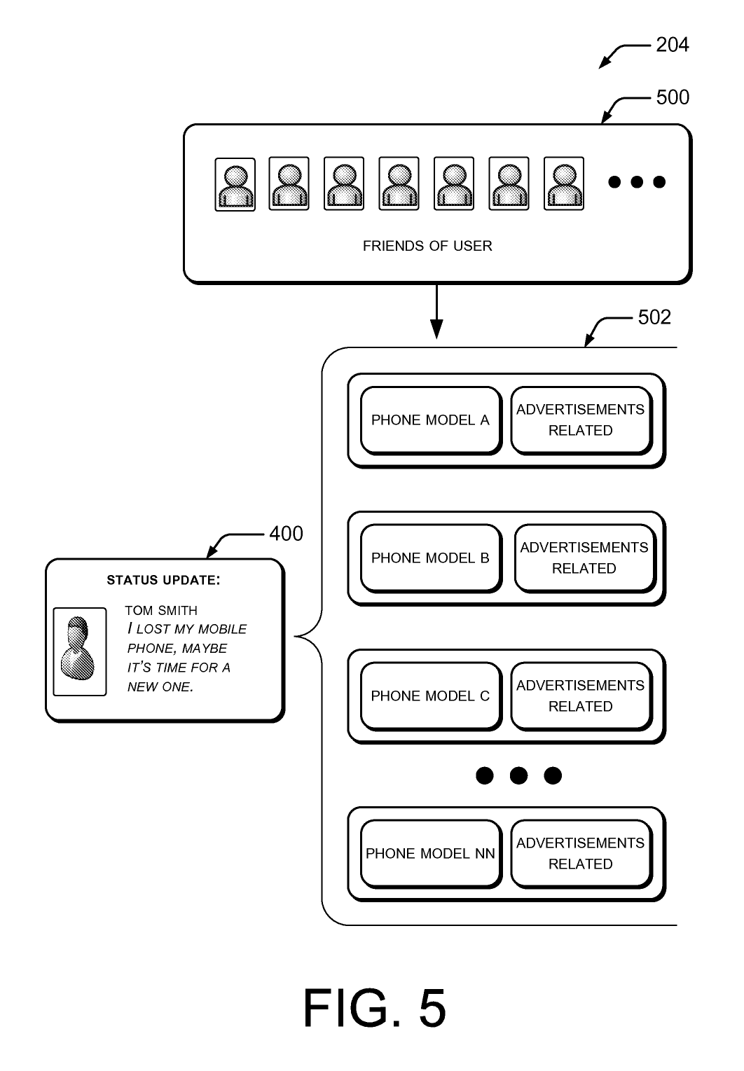

FIG. 5 shows an example process 204 for presenting to the friends the plurality of candidate products targeted towards the intent to the friends (discussed at a high level above). Block 500 illustrates friends of the user 102 from the social network.

Initially, advertisers provide products or services into an auction bidding system. The auction bidding system provides competition for inventory on the social advertisement voting. The results from the auction bidding system are based on a product being similar to the commercial intent given users profile, a product's social reputation rated by the friends, and a bidding price from the advertisers. The products from the advertisers satisfying the auction bidding criteria are identified as the plurality of candidate products 502.

The TSA application 110 may retrieve the plurality of candidate products 502 from the online database 116. The plurality of candidate products 502 include “Phone Model A” with “Advertisements Related,” “Phone Model B” with “Advertisements Related,” and so forth. The friends 500 may compare the different products to make an informed decision, may recommend a product based on personal experiences, or may recommend a product based on data.

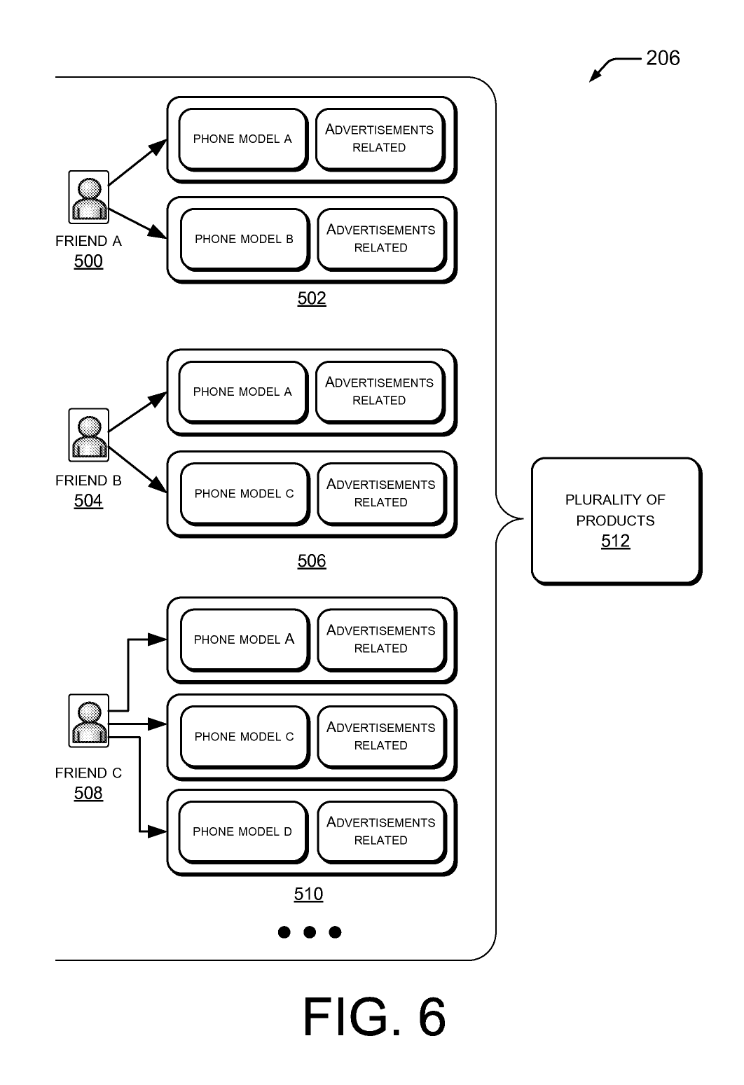

FIG. 6 shows an example process 206 for receiving input from the friends for the plurality of candidate products to identify the plurality of products. A voting model involves active participation from the friends by encouraging them to vote for products in order to help the user 102. An example illustrates the voting process with three friends of the user 102. The process is not limited to a particular number of friends in the voting process or limited to a particular number of products to be voted on by the friends.

For example, Friend A 500 votes for “Phone Model A” and “Phone Model B” 502. Friend B 504 submits votes for “Phone Model A” and “Phone Model C” 506. In addition, Friend C at 504 submits votes for “Phone Model A,” “Phone Model C,” and “Phone Model D” 506. Phone Model A received the most votes from the friends. In an implementation, the products receiving the most votes are placed in numerical order to be displayed. Thus, the plurality of candidate products that receive the most votes from the friends are identified as the plurality of products 512.

### Exemplary User Interface Implementations

FIGS. 7-11 show other illustrative user interfaces (UI) that are usable with the targeted social advertisements shown in FIG. 1. Some computing devices have large touch-screen interfaces, alpha-numeric keypads, and other forms of input and display. The UIs described below are shown with a touch-screen interface, but any type of interface is available. The UIs include buttons, such as command buttons that provides the user 102 a simple way to trigger an event or to interact with dialog boxes. The following descriptions will focus on features that are different for other implementations of the user interface.

FIG. 7 shows an illustrative user interface (UI) 700 for presenting a hint to the user 102 when commercial intent has been detected of the user 102. The figure also illustrates the examples of social network scenario.

In an implementation, the user interface pane 700 is a browser-based UI 702 that presents the webpage from the social networking website. The one or more command bars 704 are shown graphically with an arrow or a pointer, a magnifying tool, up and down arrows, and a backward arrow, although other representations may be used.

At 706, shown is a picture of the user, Tom Smith on his webpage. Also at 706, the user 102 states, “I lost my mobile phone, maybe it's time for a new one.” As mentioned previously, based on identifying keywords from the comment, the TSA application 110 detects the commercial intent of the user 102. Other components, such as an intent targeting model component may also perform these functions.

At 708, the hint presented to the user includes “Start A Vote.” The hint to the user 102 is to activate the voting process to gather input on the products available to satisfy the commercial intent of the user 102.

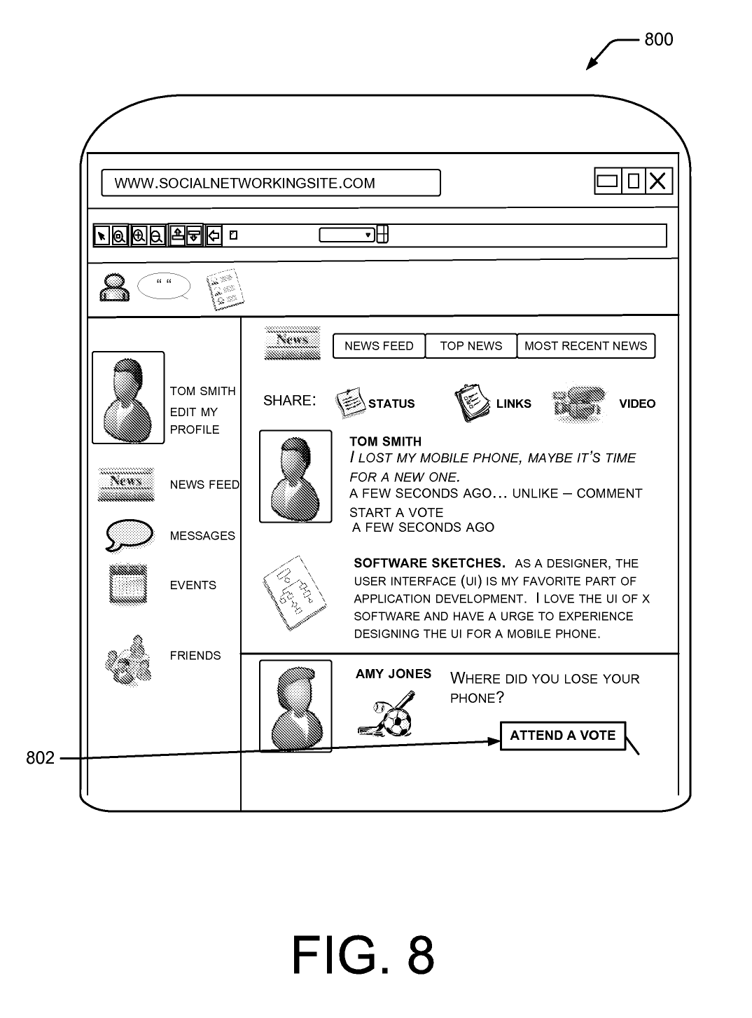

FIG. 8 shows another illustrative UI 800 for presenting a hint to the friends when commercial intent has been detected of the user 102. The UI 800 is similar to the UI 700 except this is the UI presented to the friends. The TSA application 110 provides the hint to the user's friends that there are ways to help the user 102 fulfill their commercial intent for the potential product. For instance, the hint presented to the friends is “Attend A Vote” 802. By activating the “Attend A Vote” 802, this starts the voting process for the friends as discussed with reference to FIGS. 5 and 6.

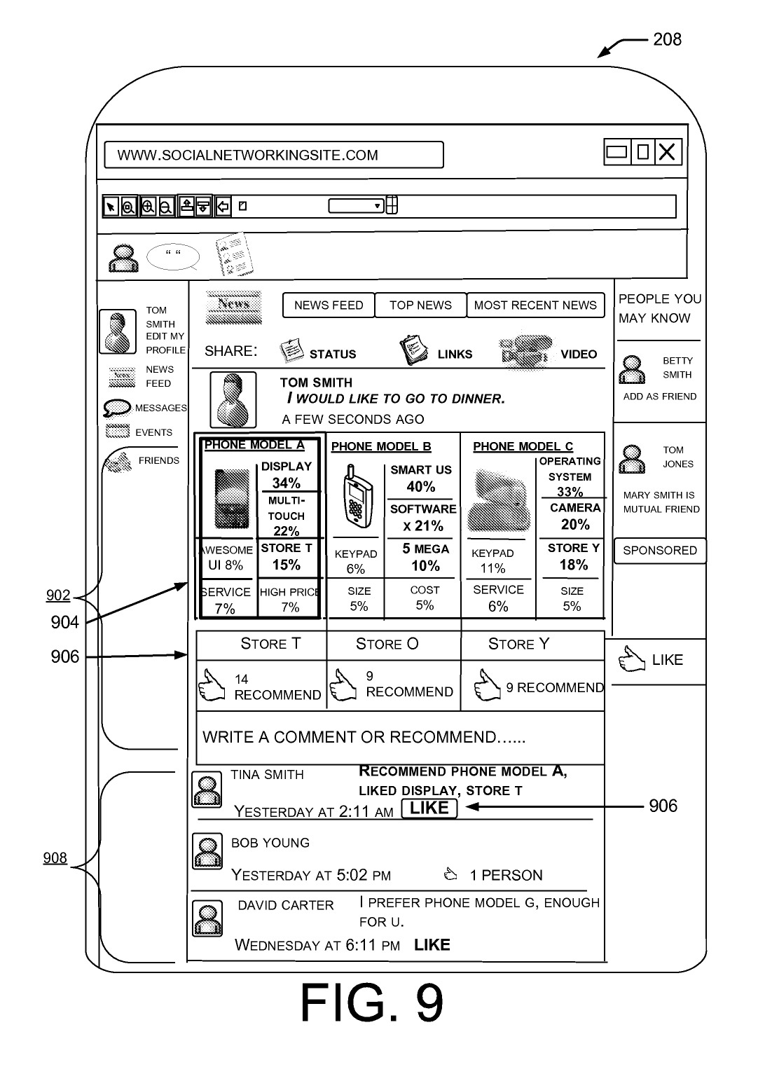

FIG. 9 shows another illustrative UI for presenting targeted social advertisements of the plurality of products 208 (discussed at a high level above). For convenience, the reference number 208 will be used to refer to the UI in FIG. 9. The description for FIG. 9 will focus on features that are not discussed with reference to FIG. 3.

At 902, an advertisers pane in the UI 208 starts from the plurality of products, “Phone Model A,” “Phone Model B,” and “Phone Model C” with the features of the products and ends at “Write A Comment or Recommend.” In an implementation, the features may be illustrated in different colors or patterns for ease of comparison. For example, any values given by the user 102 or the friends for “display” features may be shown in a yellow color, while any values given by the user 102 or the friends for “cost” features may be shown in a green color, and the like. This could be done with a drop-down menu when the user 102 right clicks on the feature being displayed or could be set to automatically provide colors for certain features.

At 904, the pane highlights a product from the social advertisements that is being reviewed most often with an outline border to distinguish the product from other products in the plurality of products. A dark border outlines “Phone Model A” and the features. In other embodiments, patterns, colors, or other types of outlines may be used to distinguish the product from the other products.

At 906, the advertisers pane 902 illustrates the advertisers that are related to the product. Shown at 904 are web buttons that are linked to the three advertisers' website, “Store T,” “Store O,” and “Store Y.” As discussed, the advertisers bid for advertising their products directed towards the commercial intent in the auction bidding system. The advertisers compete in the auction based on a similarity of their product to the commercial intent of the user, a social reputation of their product from the friends, and a price for their product. If the advertisers win the auction in the auction bidding system, their link is put on the advertisers pane 904. In other implementations, button graphics, web badges, or stickers may be used as displays to link to each advertiser's website.

The advertisers may desire analysis of the targeted social advertisements. For example, the advertisers may want to know a number of click-throughs on their products to determine the effectiveness of their targeted social advertisements. Thus, the TSA application 110 measures the number of click-throughs with permission from the user 102 and friends to share the data with the advertisers. In another implementation, the TSA application 110 also calculates a number of times an advertisement for the product may be forwarded from one individual to another.

Also, the advertisers may want to know a number of different individuals that clicked on their products, a time period of clicks, along with recommendations, comments, or ratings about them. As discussed above, the TSA application 110 may receive or collect information from the user 102 and friends who have given permission for their data to be collected and analyzed as part of being a member of the social network. Thus, the TSA application 110 identifies the number of different individuals that clicked on the products, tracks the number of clicks in time periods for several hours to several days, and provides the recommendations, the comments, and the ratings to the advertisers. In some instances, the advertisers may post the recommendations, the comments, or the ratings on their own websites, with links on their websites to the webpage on the social network.

At 908, the UI 208 illustrates conversation histories of the friends, which include information about which friend voted for a product, which friend voted for a feature of a product, and/or which friend voted for an advertiser selling a product. As shown, Tina Smith submits, “Recommend Phone Model A, liked display, Store T.” This comment is shown as being submitted yesterday at 2:11 am.

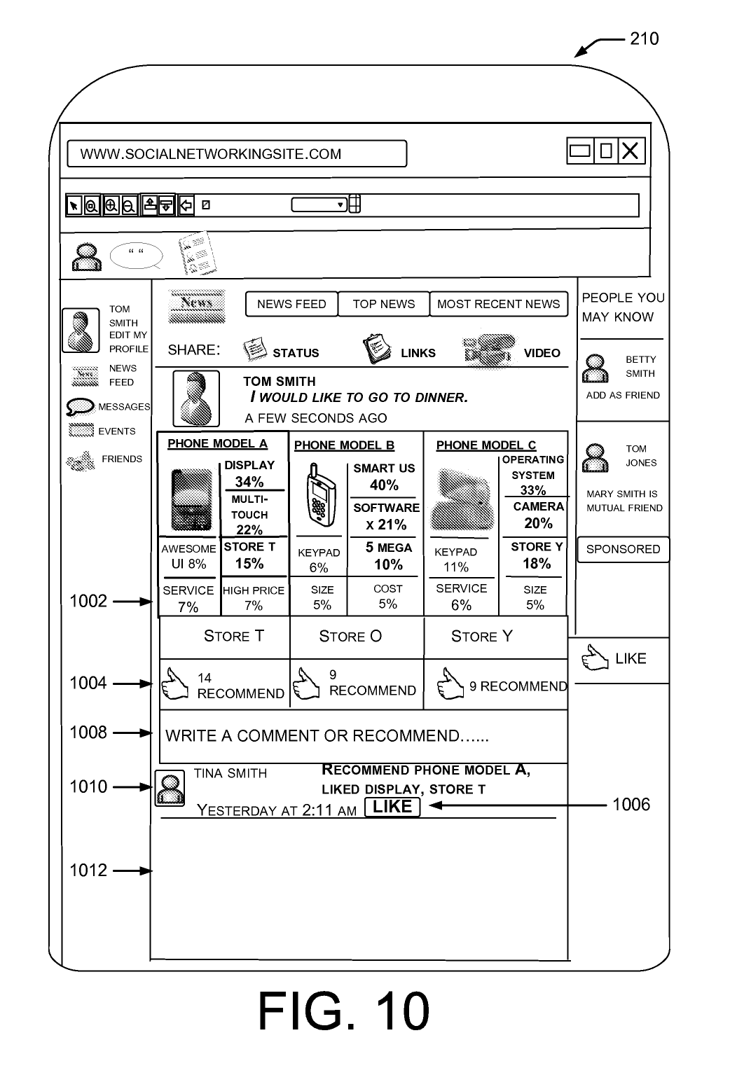

FIG. 10 shows another illustrative UI for receiving input on features, recommendations, links, or comments 210 (discussed at a high level above). For convenience, the reference number 210 will be used to refer to the UI in FIG. 10. The description for FIG. 10 will focus on features that are not discussed with reference to FIGS. 3 and 9.

The user 102 or the friends may view the UI 210. The UI 210 provides multiple ways to vote for the product using the buttons on UI 210. One technique for voting is by way of the features. For example, shown at 1002 is “Service 7%.” The user 102 or the friends may click on this feature 1002 of the plurality of products in an interactive format. This counts as a vote. In an implementation, an additional block pops up to indicate the vote for the product rather than change the percent number. For example, the 7% remains the same but another block below it indicates “1 friend” to indicate the vote. In another implementation, the input by the user 102 causes a recalculation of a number of votes that may change the percent number. In another implementation, the input may cause the recalculation of the number of votes and the rearrangement of an order of presenting the features for the plurality of products.

Another technique for voting is by clicking on “Recommend Button” with a thumbs-up icon 1004. For Phone Model A, Recommend Button 1004 displays that fourteen friends have recommended the product. The recommendation may be based on Phone Model A being relevant to the commercial intent of the user 102 or the recommendation may be based on the friend's own experience with Phone Model A. The user 102 or the friends may click on the “Recommend Button” which means voting for the product and recommending the product to other friends. The UI 210 will make changes in the number shown in the Recommend Button 1004 to reflect a current number of votes.

Yet another technique for voting is by clicking on the “Like” button 1006. Here, a friend may vote for the product currently being discussed in their conversation history. For example, Tina Smith recommends Phone Model A and may click the “Like” button to vote for the product here.

At 1008, the UI 210 displays “Write A Comment or Recommend” pane to receive comments or recommendations about the products or the advertisers from the user 102 or the friends. The UI 210 then displays the comments or recommendations in this pane. Also, the UI 210 displays one conversation history of one friend, Tina Smith 1010. In addition, the UI 210 may be activated to hide other conversation histories of other friends 1012 to make the conversation pane shorter.

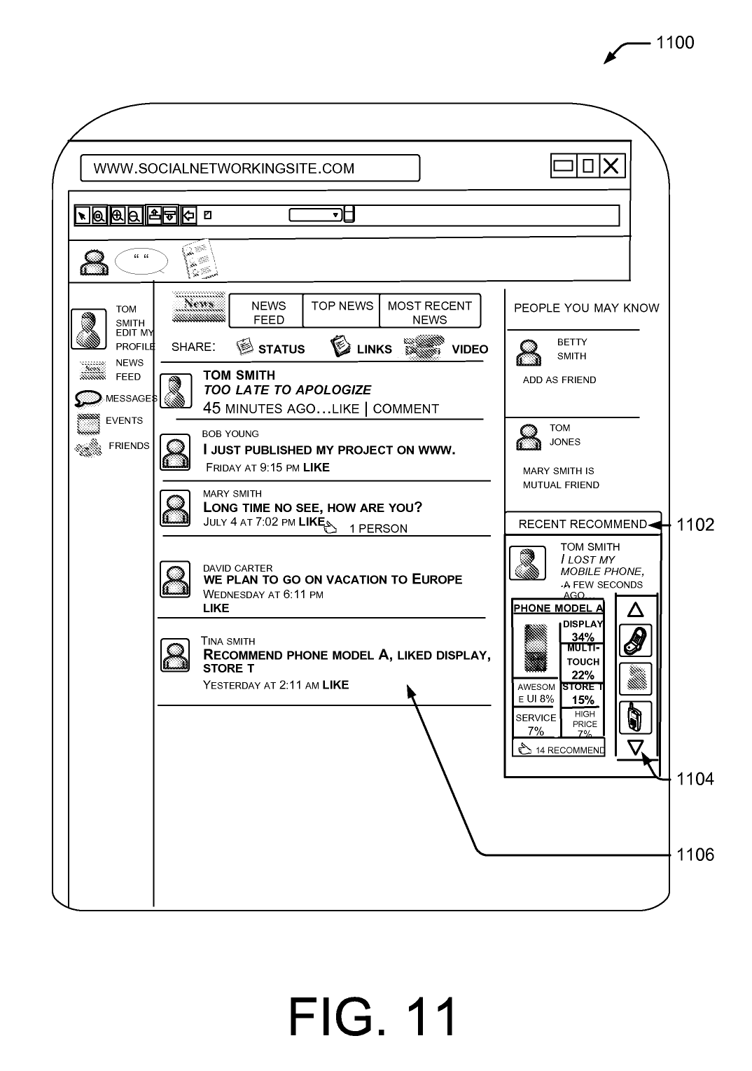

FIG. 11 shows another illustrative UI 1110 for displaying a targeted social advertisement in a side pane and the plurality of products in a scroll form.

At 1102, the UI 1110 displays a banner “Recent Recommend” with an image and features of the product that is most recently recommended in a side pane.

At 1104, the UI 1110 presents images as thumbnails of the plurality of products in a scrolling form in the side pane. The user 102 may switch from one product to another product using slides.

At 1106, the UI 1110 shows the conversation histories of the user 102 and friends.

### Social Networking Server

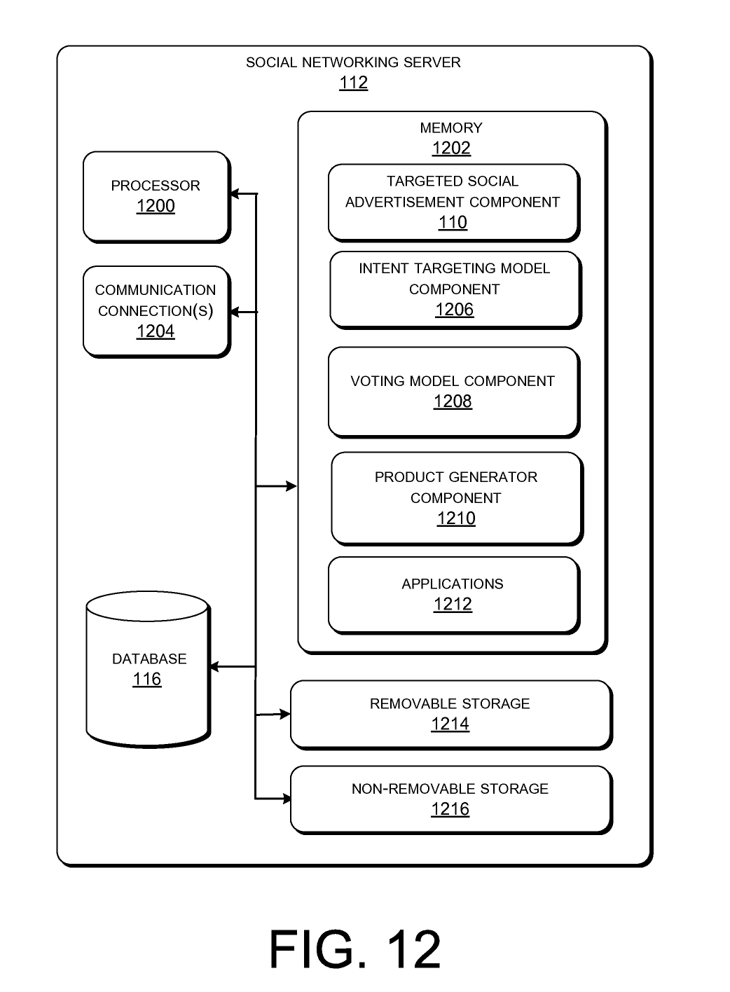

FIG. 12 is a block diagram showing selected components in a representative social networking server 112 that may be used to implement the TSA application 110. In one illustrative configuration, the social networking server 112 has processing capabilities and memory suitable to store and to execute computer-executable instructions. The social networking server 112 includes one or more processor 1200, a memory 1202, and a communication connection(s) 1204. The communication connection(s) 1204 provide access to communicate over the network(s) 114 with the computing device 108.

The processor 1200 may be implemented as appropriate in hardware, software, firmware, or combinations thereof. Software or firmware implementations of the processor 1200 may include computer-executable or machine-executable instructions written in any suitable programming language to perform the various functions described.

Memory 1202 may store program instructions that are loadable and executable on the processor 1200, as well as data generated during the execution of these programs. Depending on the configuration and type of computing device, memory 1202 may be volatile (such as random access memory (RAM)) and/or non-volatile (such as read-only memory (ROM), flash memory, etc.).

The communication connection(s) 1204 may include access to a wide area network (WAN) module, a local area network module (e.g., WiFi), a personal area network module (e.g., Bluetooth), and/or any other suitable communication modules to allow the social networking server 112 to communicate over the network(s) 114.

Turning to the contents of the memory 1202 in more detail, the memory 1202 may store the targeted social advertisement application component 110, an intent targeting model component 1206, a voting model component 1208, a product generator component 1210, applications 1212, and the database 116. Although shown as separate components, the TSA application component 110, the intent targeting model component 1206, the voting model component 1208, and the product generator component 1210 may be implemented as one or more applications or modules, or may be integrated as components within a single application.

The TSA application 110 may work in operation with the intent targeting model component 1206. The functions described may be performed by the TSA application 110 and/or the intent targeting model component 1206 or even other components. Alone or in combination, these two components may receive many types of input information, calculate layout of the targeted social advertisements based at least in part on based at least in part on an optimal aspect ratio of space available for display, generate the targeted social advertisements, detect commercial intent, identify one or more keywords from comments and for the products, and perform other functions. Furthermore, the two components may also retrieve a webpage of a user expressing commercial intent for a potential product and retrieve a plurality of candidate products targeted towards the commercial intent of the user for the potential product. The components may track click-throughs for the advertisers as well as the other measurements.

The voting model component 1208 interacts with the TSA application 110 and the intent targeting model component 1206. The voting model component 1208 receives a number of votes for the plurality of candidate products from friends of the user 102, and interacts with information from the other components to receive interaction and customization instructions from the user 102.

The product generator component 1210 creates, builds, or generates the targeted social advertisements. The product generator component 1210 provides a visualization of the plurality of products with values of features based on receiving a highest number of votes assigned by the friends in recognizing the commercial intent of the user 102. In addition, the product generator component 1210 defines selection and arrangement of items in context of features of the products in the targeted social advertisements, and provides visualization of the products and features. The processes described above with references to the figures above may be performed by any of the modules or combination of the modules shown here.

The social networking server 112 may include the database 116 to store a collection of input, the plurality of candidate products, the plurality of products, the targeted social advertisements, different analysis performed on the comments of the user 102, and custom views created of the features in the targeted social advertisements.

The social networking server 112 may also include additional removable storage 1214 and/or non-removable storage 1216 including, but not limited to, magnetic storage, optical disks, and/or tape storage. The disk drives and their associated computer-readable media may provide non-volatile storage of computer readable instructions, data structures, program modules, and other data for the computing devices. In some implementations, the memory 1202 may include multiple different types of memory, such as static random access memory (SRAM), dynamic random access memory (DRAM), or ROM.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The social networking server 112 from FIG. 12 may be implemented in various types of systems or networks. For example, the social networking server 112 and the computing device 108 may be a part of, including but is not limited to, a client-server system, a peer-to-peer computer network, a distributed network, an enterprise architecture, a local area network, a wide area network, a virtual private network, a storage area network, an overlay network, and the like.

Various instructions, methods, techniques, applications, and modules described herein may be implemented as computer-executable instructions that are executable by one or more computers, servers, or telecommunication devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. The functionality of the program modules may be combined or distributed as desired in various implementations. An implementation of these modules and techniques may be stored on or transmitted across some form of computer-readable storage media.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A user interface displayed on a computing screen, the user interface comprising:
a pane to display a comment with commercial intent submitted by a user in a social network, the commercial intent being detected for a potential product by identifying one or more keywords from the comment;
an advertising pane to display a plurality of candidate products targeted towards the commercial intent of the user for the potential product;
one or more command buttons on the advertising pane to prompt voting as a recommendation for the plurality of candidate products from friends of the user; and
a results pane to present targeted social advertisements of a plurality of products selected from the plurality of candidate products in response to the commercial intent and votes from the friends of the user in the social network.

2. The user interface of claim 1, wherein the targeted social advertisements highlight a product that is being reviewed most often with an outline border to distinguish the product from other products in the plurality of products.

3. The user interface of claim 1, wherein the targeted social advertisements of the plurality of products further present names of advertisers on one or more command buttons to be activated to websites of the advertisers.

4. The user interface of claim 1, wherein the targeted social advertisements of the plurality of products further include ratings for each advertiser provided by the friends.

5. The user interface of claim 1, further comprising:
one or more command buttons on the results pane to display values of features for the plurality of products that count as votes toward a product upon being activated; and
the results pane to change an order of presenting the targeted social advertisements of the plurality of products based on a recalculated number of votes being received from the user and the friends in the social network.

6. The user interface of claim 1, further comprising a comment pane to add comments for the plurality of products or for advertisers from the user or from the friends.

7. The user interface of claim 1, further comprising measuring a number of click-throughs on the targeted social advertisements of the plurality of products to determine an effectiveness of the targeted social advertisements.

8. The user interface of claim 1, further comprising presenting the targeted social advertisements of the plurality of products in a side-by-side display to enable the user to compare at least two or more products with values for features.

9. The user interface of claim 1, further comprising presenting a display of a product and rating of features of the product in a side pane and presenting displays of other products from the plurality of products in a scrolling form in the side pane.

10. A system comprising:
a processor;
an intent targeting model component executed by the processor to retrieve a webpage of a user expressing commercial intent for a potential product and to retrieve a plurality of candidate products targeted towards the commercial intent of the user for the potential product;
a voting model component executed by the processor to receive a number of votes for the plurality of candidate products from friends of the user; and
a product generator component executed by the processor to provide a visualization of a plurality of products with values of features based on receiving a highest number of votes assigned by the friends in recognizing the commercial intent of the user.

11. The system of claim 10, wherein the plurality of candidate products being retrieved was identified from an auction based on a similarity of a product to the commercial intent of the user, a social reputation of a product from the friends, and a price for a product.

12. The system of claim 10, wherein the intent targeting model component executed by the processor is to further send a hint to the friends to help the user fulfill the commercial intent for the potential product, the hint is a link to the plurality of candidate products.

13. The system of claim 10, wherein the interactive social advertising component executed by the processor is to further provide a hint to the user that commercial information is available to satisfy the commercial intent by activating one or more command buttons for the commercial information.

14. The system of claim 10, wherein the intent targeting model component executed by the processor is to further analyze one or more keywords from the webpage of the user to determine the commercial intent for the product.

15. The system of claim 10, wherein the values of features includes:
providing one or more advertising keywords for the plurality of products using a database and a product search result; and
tagging the one or more advertising keywords with a popularity level assigned by the user and the friends.

16. One or more computer-readable storage media encoded with instructions that, when executed by a processor, perform acts comprising:
presenting a plurality of products selected by friends of a user in a social network from a plurality of candidate products, the selecting by the friends based on detecting a commercial intent of the user for a potential product; and
receiving an input on features of the plurality of products in an interactive format, the input causes a recalculation of a number of votes to rearrange an order of presenting the plurality of products.

17. The one or more computer-readable storage media of claim 16, further comprising receiving another input on an advertiser's link shown with the plurality of products.

18. The one or more computer-readable storage media of claim 16, further comprising receiving another input on a recommendation button to recommend a product from the plurality of products.

19. The one or more computer-readable storage media of claim 16, further comprising receiving another input for comments about a product from the plurality of products or about an advertiser.

20. The one or more computer-readable storage media of claim 16, further comprising presenting conversation histories which include information about which friend voted for a product, which friend voted for a feature of a product, or which friend voted for an advertiser selling a product.
